(19) United States
(12) Patent Application Publication
(10) Pub. No.: US 2012/0058822 A1
(43) Pub. Date: Mar. 8, 2012

(54) SELECTION INTERFACE

(76) Inventors: Frank Butterworth, Disley Cheshire (GB); Malcolm Shannon, Stockport Cheshire (GB)

(21) Appl. No.: 13/254,343

(22) PCT Filed: Mar. 2, 2010
(86) PCT No.: PCT/GB2010/050362

§ 371 Date: Nov. 10, 2011

(30) Foreign Application Priority Data
Mar. 7, 2009 (GB) 09039694

(51) Int. Cl. A63F 13/00

(52) U.S. Cl. 463/30

(57) ABSTRACT

A selection interface has a control module, a display with screen operable to display an image, a region selector and an element selector. The region selector enables the selection of a single region of the image and further operable to cause the display to display an expanded view of the selected single region thereby facilitating selection of any one of the elements within the selected region. The selection interface is suitable for use in implementing a selection game such as spot the ball in which case the image is a digital photograph of a ball game which has been cropped and sized so that it has the desired dimensions and the image is divided into a plurality of square regions. The center of the ball is recorded by overlaying an object of a substantially similar size, shape and orientation with the ball and recording the center of that object when the two objects coincide. The element containing the center of the ball is found and recorded. The ball is then electronically removed from the image. Users attempt to guess the location of the element containing the center of the ball and select the same using the selection interface.

The present invention relates to a selection interface and in particular to a selection interface which is suitable for use in implementing a selection game, most particularly a game such as ‘spot the ball’.

Spot the ball is a game which became very popular in the UK in the 1980s. It was principally run by newspapers which would feature an image, typically a photograph, depicting a scene from a ball sport, particularly association football, from which the ball had been removed. The readers were invited to indicate were they believed the true position of the centre of the ball to be by marking the image with a cross. Readers could make a plurality of guesses and enter a competition by returning their marked image to the newspaper distributor along with a suitable fee which was based on the number of guesses.

The entrant with the guess closest to the true position of the ball would win a cash prize. Alternatively, a prize would be awarded for a set number of the closest guesses, i.e. the entrants that made these guesses shared the prize money. The share that each such entrant received may be determined by the proximity of that entrants' guess to the true position of the ball.

The true position of the ball could be defined as the centre of the ball as in the original photograph, resulting in a game of skill. Alternatively, the true position of the ball could be defined as that chosen by a panel of experts, since legislation in many countries may prohibit the act of gambling on an event which occurred in the past.

Typically, for each competition there would be several entrants who selected the correct area and, in order to distinguish several close guesses, the images were enhanced using a dedicated magnifying device. This process of determining the closest guess is laborious and non-trivial. Owing to the fact that the different guesses are made on several different copies of the image and the widths of the crosses marked by different entrants are different, this selection process is also not very accurate.

It is the object of the present invention to provide a new selection interface which is suitable for use in implementing a selection game of the type discussed above which at least partially overcomes or alleviates these problems.

According to a first aspect of the present invention there is provided a selection interface, suitable for use in implementing a selection game, the selection interface comprising: a control module; a display apparatus suitable for displaying an image wherein the image is divided into a plurality of regions, each region comprising a plurality of individually selectable elements; element selection means operable to enable the selection of any one of the individually selectable elements; and region selection means operable to enable the selection of a single region and further operable to cause the display apparatus to display an expanded view of the selected single region thereby facilitating selection of any one of the elements within the selected region.

In this way, there is provided a selection interface suitable for use in implementing a selection game such as spot the ball with an increased number of possible outcomes from which to select for a given display apparatus size. This will further aid the distinction between several close selections and make for a quicker, simpler and more accurate determination of the winner.

The control module may be a local or remote server or processing unit or any other suitable electronic device. The display apparatus may be a personal computer, a laptop, a personal digital assistant (FDA), a mobile telephone or a dedicated display device.

The display apparatus may be integrated into the control module or be connected thereto by a suitable link. The link may be wired, wireless or a mixture thereof as required or desired. The display apparatus could be remote from the control module and connected via a suitable network. Suitable networks might include the interne, public telephone network (fixed or cellular), local area network (wireless or fixed line) or any other suitable network. This connection may be an Ethernet connection, Wi-Fi, radio signal or any other suitable combination of hardware and software.

There may be one central control apparatus and a plurality of remote display apparatuses. In particular, the central control apparatus may be adapted such that any suitably adapted display device may connect to the central control apparatus via a suitable connection or network.

The region and element selection means may each comprise any or all of the following: a directional control; a selection control; and a de-selection control. These may be implemented by a suitable pointer. Suitable pointers may include: a mouse or track pad, a key pad, a joy stick, a touch screen or any other suitable pointer as is appropriate. The region or element currently available for selection may be indicated by the display apparatus in any convenient manner. This may be by means of visual highlighting, display of a cursor or similar. In a preferred embodiment, the region and the element selection means are provided by the same pointer. In such embodiments, the first actuation of a selection control may select a region and a subsequent actuation of the selection control may select one or more elements. There may also be a de-selection means operable to cancel the selection of the selected region in order to enable selection of another region. For embodiments for which the display apparatus is a dedicated display device, the region and element selection means are preferably implemented by way of a touch screen.

The regions may all be substantially the same size. Alternatively the regions could vary in size depending on the area of the image that they occupy.

The aspect ratio of the individual regions may be substantially the same as that of the image. Alternatively, the individual regions could have any other shape as appropriate. In one preferred embodiment, the regions are substantially square.

In embodiments in which the aspect ratio of the individual regions is substantially the same as that of the image, the expanded view of the selected single region could be substantially the same size as the original image. Alternatively, it could be smaller or larger than the original image as desired. It may occupy substantially the same area of the display apparatus as the original image such that the original image is not visible. Alternatively, the expanded view may be translated relative to the original image so as to partially obscure the image but leaving at least part of it visible. Preferably, the translation is of suitable length and direction so that the visible portion includes the area surrounding the selected region. This can aid the user's selection.

In embodiments wherein the selection interface is operable to display a cursor on the display apparatus, the position of the cursor is preferably controllable by the region or element selection means. Preferably, the cursor is controllable by the region selection means before the selection of a region of the original image and the element selection means after the selection of such a region. While the cursor is on the image, a selection can be made using the region or element selection means as appropriate. The position of the cursor may be controlled using the directional control of the region or element selection means and selection may be achieved by actuation of the selection control.

The cursor may take the form of a cross. This may be in the shape of an X or a +. In this context, a + may be a cruciform shape for which each of the arms is substantially parallel to at least on of the borders of the image whereas an X may be a cruciform shape whose arms are not substantially parallel to any of the borders of the image. Furthermore, the arms of the X may or may not be substantially mutually perpendicular as required or desired. In such embodiments, the user makes a selection by using the region or element selection means as appropriate to place the centre of the cross over the region or element that he/she believes the centre of the object to occupy and to select this region or element.

In an alternative embodiment, the cursor may comprise an image which is of a substantially similar size, shape and appearance as a particular object. Preferably, the particular object is the object the position of which is to be selected using the selection interface. This can aid a user in making an accurate estimate of a region or element to select. The cursor may further comprise additional features as appropriate to distinguish the cursor from the image. In such embodiments, the user makes a selection by using the region or element selection means as appropriate to place the cursor over the position that he/she believes the object to occupy, then subsequently actuating the selection control provided. The region or element at the centre of the cursor position will then be selected.

In a further embodiment, the user is free to choose the form of the cursor to be of one of the forms above or any other suitable form. In such embodiments, a plurality of cursor forms may be displayed to the user alongside said image. The desired cursor form may be selected by use of cursor selection means. The cursor selection means may comprise the same pointer as the region and/or element selection means.

Preferably, in embodiments in which both the expanded region and the area surrounding the selected region are both visible after selection of a region, the selection interface may be operable to display a first and second cursor on the display apparatus such that the positions of the first and second cursors are both controllable by the element selection means. These cursors may have the same or different forms as desired. For example, the first cursor, appearing on the original image, may be of the form of the object which the user is attempting to find while the second cursor, appearing on the expanded region, may be of the form of a + or an X.

The image may appear as an unbroken image and the user can select the point that they believe to be closest to the centre object, which will prompt the display apparatus to show an expanded view of the region that this falls inside. Alternatively the image may have a visible grid to indicate to users the boundaries between the plurality of regions. This may aid selection when the true centre of the object is proximate to any of these boundaries.

The individually selectable elements may comprise a single pixel of the expanded view of the selected single region or it may comprise a plurality of adjacent pixels, for example a 2×2 square of pixels.

The selection interface may be used to play a game of skill, with the true position of the object being that of the object removed from the image. Alternatively, or in addition, it could be used for gambling and, as such, the true position of the ball may be that defined as the position as judged by a judging means. The judging means may comprise one or more person, dedicated recognition software or some other suitable means.

Once a selection has been made, the coordinates of the selected pixel are stored in the control module. Players may make a plurality of selections. In a preferred embodiment, the user is required to make a payment for each selection. The payment is made by a suitable payment means which may be an electronic payment system, a coin slot, a bank note slot or any other suitable payment means.

Preferably, for embodiments requiring an electronic payment the player must set up a dedicated account by registering certain details and obtaining credit by making a minimum payment. This credit can be used to pay for selections and extra credit can be bought as necessary.

The game may last for a set time period after which a jackpot prize may be awarded to any player who selects the correct pixel. In the event that more than one player selects the correct pixel, the jackpot prize may be shared between all such players. Near miss prizes may be awarded for a fixed number of selections which are closest to the correct pixel.

As more players make selections and the total money collected increases, the jackpot and near miss prizes may become also increase. Alternatively, the jackpot and near miss prizes may be fixed amounts or may increase in proportion to the number of selections up to a maximum value.

In the event that no players select the correct pixel, the jackpot prize may be collected to form a rollover prize. This may be awarded to the player or players who select the closest pixel to the true pixel in a dedicated rollover game.

The selection interface may be utilised to play a spot the ball game. In such games, the image may depict a scene from a ball game with the ball removed and is displayed on the display apparatus. The ball game may be association football, tennis, golf, cricket, baseball, basketball or any other ball game as desired. Preferably, the ball used in the ball game is substantially spherical. Alternatively, the ball may be oval or any other shape. In embodiments wherein the ball is not spherical, it may further be possible to select an appropriate orientation for the ball in addition to a selected location. The player may have a choice of several different ball games.

The selection interface may require players to log on. The log on process may require a player to verify their age. The log on process may automatically identify the location of the players or may require the player to specify their location. The identification of the location of a player may be by performed using the Internet Protocol (IP) address of that player. The selection of available ball games may vary depending on the location of the player. This can do much to ensure that the operation of the game complies with relevant national legal requirements.

According to a second aspect of the present invention, there is provided a method of selecting an individual element of an image using a selection interface according to the first aspect of the present invention, comprising the steps of: displaying an image on the display apparatus; using the region selection means to select a region; causing the display apparatus to display an expanded view of the selected region; and using the element selection means to select an element from the selected region.

The second aspect of the present invention may incorporate any or all features of the first aspect of the present invention as is desired or appropriate.

In order that the invention can be more clearly understood it is now described further below with reference to the accompanying drawings, of which:

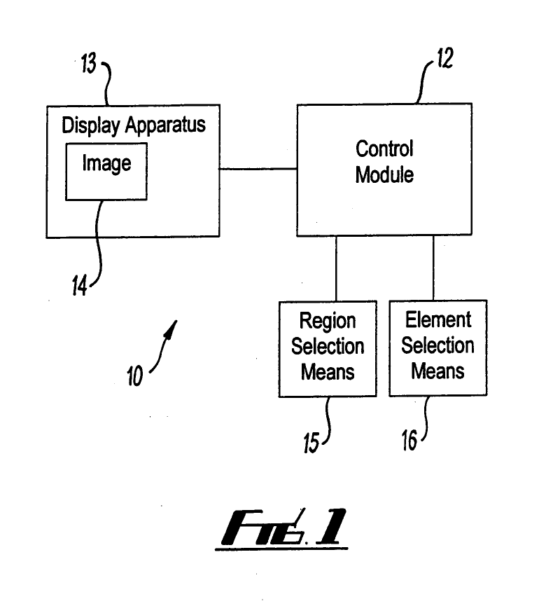

FIG. 1 is a schematic block diagram showing a selection interface according to the present invention;

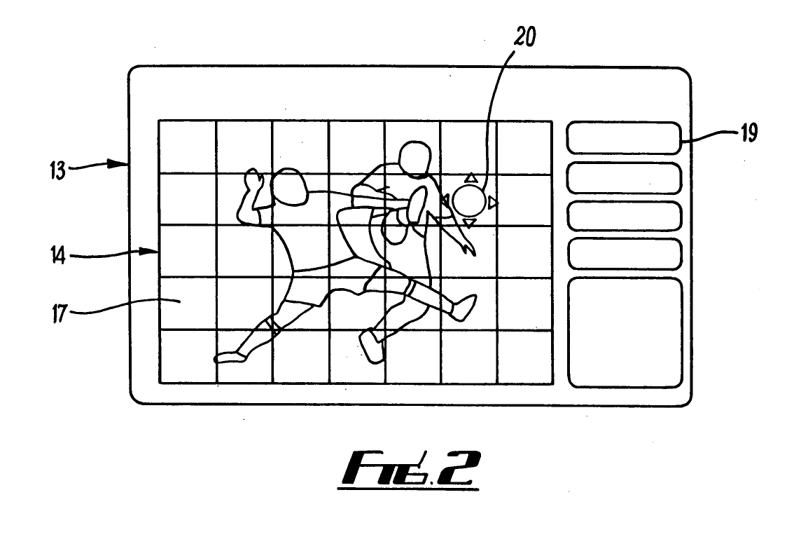

FIG. 2 is a view of the display apparatus showing an image depicting a screen from a football match;

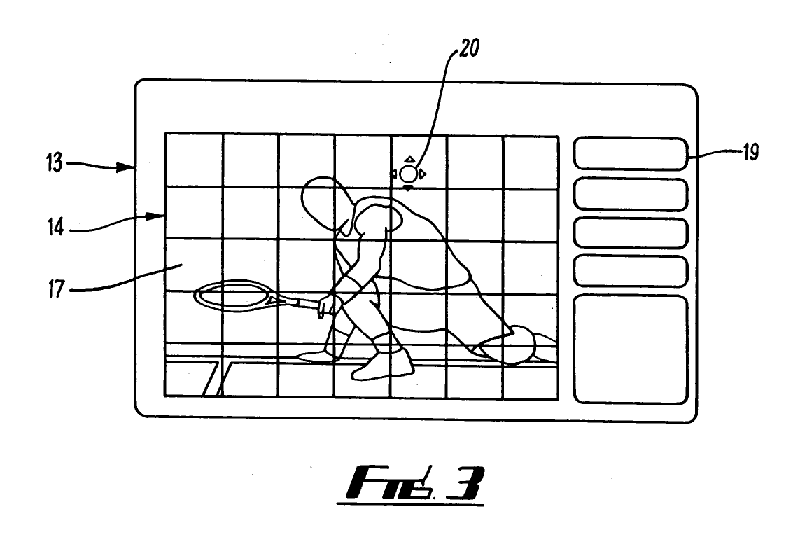

FIG. 3 is a view of the display apparatus showing an image depicting a screen from a tennis match;

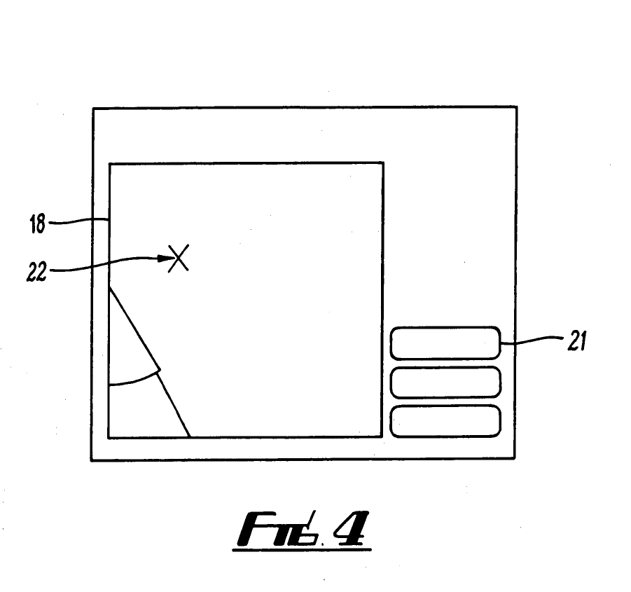

FIG. 4 is a view of the display apparatus showing an expanded region of the image depicted in FIG. 2; and

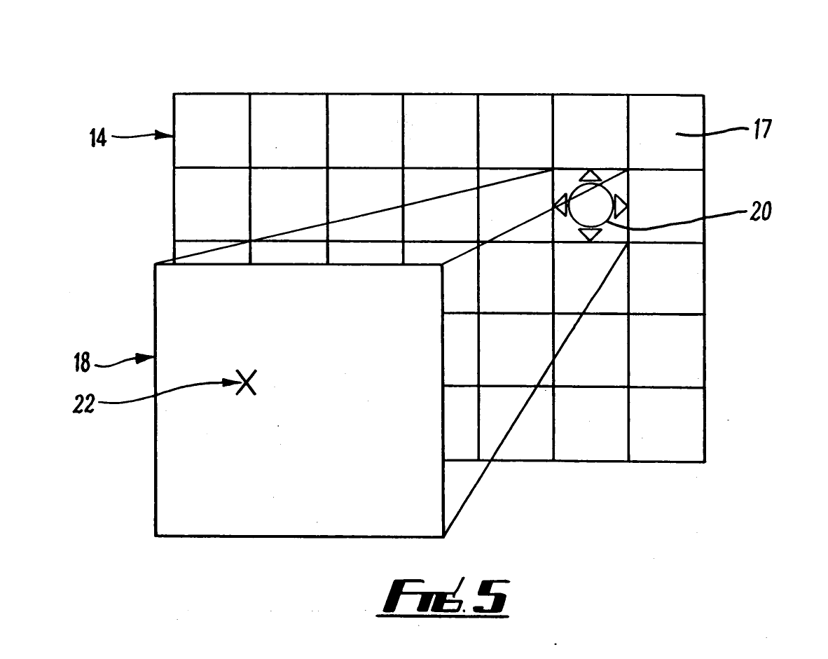

FIG. 5 is a schematic view showing an image and an expanded view of one selected region as would be displayed on the display apparatus.

Referring first to FIG. 1, a selection interface 10 comprises: a control module 12; a display apparatus 13, having a screen operable to display an image 14; a region selection means 15; and an element selection means 16. The selection interface 10 is suitable for use in implementing a selection game such as spot the ball, as will be described below.

A digital photograph of a ball game is selected, cropped and sized so that it has the desired dimensions. For example, the image might be chosen to have an aspect ratio of 7:5 so that it can be divided into 35 square regions (7 across by 5 down). Preferably, the number of pixels is as high as possible. For example, satisfactory results have been found with images 14 for which each of these regions comprises 400×400 pixels.

The centre of the ball is recorded by overlaying an object of a substantially similar size, shape and orientation with the ball and recording the centre of that object when the two objects coincide. For ball games utilising balls which are substantially spherical, this object may be a circle with substantially the same size radius as the ball. Alternatively, the object may be an image of the ball which was removed from the original image. The pixel containing the centre of the ball is found and recorded. The ball is then electronically removed from the image 14. These operations may be performed by suitable imagery manipulation software as will be obvious to one of ordinary skill in the art.

Alternatively, the ball is first electronically removed before the centre of the ball is recorded as judged by some judging means. This is achieved by overlaying an object of the same size, shape and orientation as the ball with the image 14. This object is moved around until it is deemed to be in the correct position by the judging means. The judging means may comprise a panel of suitable persons.

The image 14 thus formed is displayed on the display apparatus 13 and the coordinates of the pixel containing the centre of the ball are cached in the control module 12.

FIGS. 2 and 3 show two such images 14 displayed on the display apparatus 13, showing football and tennis scenes respectively. The images 14 are divided into a plurality of regions 17. The display apparatus 13 may also display additional information/statistics relating to the game. This may be displayed in dedicated boxes 19 or in any other fashion. This additional information may comprise any or all of the following: the time remaining before expiration of the game, the number of selections made by the current player and the number of subsequent selections that the player may make.

Players are invited to use the region selection means 15 to select the region 17 in which they believe the true position of the ball to lie. This may be achieved by controlling the position of a cursor 20 on the screen so that it is on the region of interest and then selecting that region. The position of the cursor may be controlled using the directional control i.e. by movement of a pointer, such as a mouse or track pad, or by operation of a key pad or a joy stick. The selection of a region of interest may be achieved by pressing a button or any other suitable user actuable control. In an alternative embodiment, when the region selection means 15 comprises a touch screen, the selection means 15 is actuated by contact with the relevant part of a touch screen.

Preferably, as shown, the cursor 20 comprises a body which is substantially the same shape and size as the missing ball and a plurality of arrows to aid its easy identification in the image 14. Alternatively, the cursor 20 could be a standard cruciform shape or any other form as desired.

Once a region 17 has been selected, the display apparatus 13 will show an expanded view of that region 17. This may replace the image 14 on the screen or may be displayed over the image 14 such that the image 14 is partially visible. Alternatively, the expanded view may be translated relative to the original image 14 so as to partially obscure the image 14 but leaving at least part of it visible. Preferably, the translation is of suitable length and direction so that the visible portion includes the area surrounding the selected region 17 so as to aid the user's selection.

Other information may also be displayed, for example the coordinates of the pixel that the cursor 20 is on may be displayed. These coordinates may vary as the cursor is moved within the region 17.

Players are invited to use the element selection means 16 to select the element in which they believe the true position of the centre of the ball to lie. This may be achieved by controlling the position of a second cursor 22 on the screen so that it is on the element of interest and then selecting that element. The position of the cursor may be controlled using the directional control i.e. by movement of a pointer, such as a mouse or track pad, or by operation of a key pad or a joy stick. The selection of an element of interest may be achieved by pressing a button or any other suitable user actuable control. In an alternative embodiment, when the element selection means 16 comprises a touch screen, the selection means 16 is actuated by contact with the relevant part of a touch screen.

FIG. 4 shows an expanded view 18 of one of the regions 17 of the image 14 shown in FIG. 2 (the region containing the centre of the cursor 20). Also displayed on the display apparatus 13 are boxes 21 for displaying additional information and a second cursor 22, the position of which is controlled by the element selection means 16. The additional information may comprise any or all of the following: the time remaining before expiration of the game, the number of selections made by the current player and the number of subsequent selections that the player may make. In this embodiment, the original image 14 is not shown.

FIG. 5 shows schematically an expanded view 18 of one of the regions 17 of an image 14 according to the present invention. Part of the image 14 is also visible on the display apparatus 13, showing the area surrounding the selected region. Also displayed on the display apparatus 13 are a first cursor 20, on the original image 14, and a second cursor 22, on the expanded region. The positions of the first cursor 20 and the second cursor 22 are both controlled by the element selection means 16. In such embodiments, additional information may also be shown on the display apparatus 13 and it may further comprise boxes 21 for display of such information.

Once a selection has been made, the coordinates of the selected pixel are stored in the control module 12. Players may make a plurality of selections. Once a selection has been made, a marker may appear on the expanded view. The marker may be of substantially the same form as the cursor 22, or any other form as required or desired. If there is more than one player, the details of the player making the selection are stored along with the coordinates of the selected pixel. In a preferred embodiment, the user is required to make a payment for each selection. The payment is made by a suitable payment means which may be an electronic payment system, a coin slot, a bank note slot or any other suitable payment means.

Preferably, for embodiments requiring an electronic payment the player must set up a dedicated account by registering certain details and making a minimum payment. This credit can be used to pay for selections and extra credit can be bought as necessary.

The game may last for a set time period after which a jackpot prize may be awarded to any player who selects the correct pixel. In the event that more than one player selects the correct pixel, the jackpot prize may be shared between all such players. Near miss prizes may be awarded to a fixed number of selections which are closest to the correct pixel.

As more players make selections and the total money collected increases, the jackpot and near miss prizes may also increase. Alternatively, the jackpot and near miss prizes may be fixed amounts or may increase in proportion to the number of selections up to a maximum value.

In the event that no players select the correct pixel, the jackpot prize may be collected to form a rollover prize. This may be awarded to the player or players who select the closest pixel to the true pixel in a dedicated rollover game.

It is of course to be understood that the invention is not to be restricted to the details of the above embodiments which have been described by way of example only.

1. A selection interface, suitable for use in implementing a selection game, the selection interface comprising: a control module; a display apparatus suitable for displaying an image wherein the image is divided into a plurality of regions, each region comprising a plurality of individually selectable elements; element selection means operable to enable the selection of any one of the individually selectable elements; and region selection means operable to enable the selection of a single region and further operable to cause the display apparatus to display an expanded view of the selected single region thereby facilitating selection of any one of the elements within the selected region.

2-66. (canceled)

67. A selection apparatus as claimed in claim 1 wherein the display apparatus is: a personal computer, a laptop, a personal digital assistant (PDA), a mobile telephone or a dedicated display device.

68. A selection apparatus as claimed in claim 1 comprising one central control apparatus and a plurality of remote display apparatuses and wherein the central control apparatus is adapted such that any suitably adapted display device may connect to the central control apparatus via a suitable connection or network.

69. A selection apparatus as claimed in claim 1 wherein the region and element selection means each comprise: a directional control; a selection control operable to select a region or element; and a de-selection control operable to cancel the selection of a selected region or element in order to enable selection of another region.

70. A selection apparatus as claimed in claim 1 wherein a region or element currently available for selection is indicated by the display apparatus by means such as: visual highlighting and/or display of a cursor and wherein said highlighting and/or the position of said cursor is controllable by the region and/or element selection means.

71. A selection apparatus as claimed in claim 70 wherein the cursor is controllable by the region selection means before the selection of a region of the original image and the element selection means after the selection of such a region.

72. A selection apparatus as claimed in claim 70 wherein the cursor comprises an image which is of a substantially similar size, shape and appearance as an object the position of which is to be selected using the selection interface.

73. A selection apparatus as claimed in claim 72 wherein the cursor further comprises additional features to distinguish the cursor from the image.

74. A selection apparatus as claimed in claim 70 wherein the user is free to choose the form of the cursor to be of one of a plurality of cursor forms.

75. A selection apparatus as claimed in claim 1 wherein the region and the element selection means are provided by a single selection control and wherein a first actuation of the single selection control selects a region and a subsequent actuation of the single selection control selects one or more elements.

76. A selection apparatus as claimed in claim 1 wherein the expanded view of the selected single region occupies substantially the same area of the display apparatus as the original image such that the original image is not visible.

77. A selection apparatus as claimed in claim 1 wherein the expanded view of the selected single region is translated relative to the original image so as to leave at least part of the original image visible.

78. A selection apparatus as claimed in claim 77 wherein the translation is of suitable length and direction so that the visible portion includes the area surrounding the selected region.

79. A selection apparatus as claimed in claim 1 wherein after selection of a single region the selection interface is operable to display first and second cursors on the display apparatus such that the positions of the first and second cursors are both controllable by the element selection means.

80. A selection apparatus as claimed in claim 1 wherein the individually selectable elements each comprise: a single pixel of the expanded view of the selected single region; or a plurality of adjacent pixels of the expanded view of the selected single region.

81. A selection apparatus as claimed in claim 1 further comprising a payment means.

82. A selection apparatus as claimed in claim 1 wherein the selection apparatus is operable to implement a spot the ball game, wherein the image depicts a scene from a ball game with the ball removed and wherein the player uses the selection region and element selection means to guess the location of the missing ball.

83. A selection apparatus as claimed in claim 82 wherein the ball used in the ball game is not substantially spherical and wherein the selection apparatus allows for the selection of an appropriate orientation for the ball in addition to the selection of its location.

84. A selection apparatus as claimed in claim 82 wherein a prize is awarded to any player who selects the correct pixel and/or for a fixed number of selections which are closest to the correct pixel.

85. A method of selecting an individual element of an image using a selection interface according to claim 1, comprising the steps of: displaying an image on the display apparatus; using the region selection means to select a region; causing the display apparatus to display an expanded view of the selected region; and using the element selection means to select an element from the selected region.
